(19) United States
(12) Patent Application Publication
(10) Pub. No.: US 2024/0214810 A1
(43) Pub. Date: Jun. 27, 2024

(54) OBSCURED ASSET ATTAINMENT

(71) Applicant: FORD GLOBAL TECHNOLOGIES, LLC, Dearborn, MI (US)

(72) Inventors: Jean de Dieu MUTANGANA, Detroit, MI (US); Mohsen BAHRAMI, San Diego, CA (US); Venkata Maruthe Ravikumara Sharma CHENGALVALA, Troy, MI (US); Hamed ASADI, Troy, MI (US); James Wilheim HEATON, Saline, MI (US)

(21) Appl. No.: 18/146,023

(22) Filed: Dec. 23, 2022

(51) Int. Cl. H04W 12/106; H04W 12/00

(52) U.S. Cl. CPC H04W 12/106; H04W 12/009

(57) ABSTRACT

A vehicle receives a request for a download and determines a size of a file to be downloaded, a plurality of repositories that include the file, and a second file also in the repositories and having a minimum size. The vehicle plans a sequence of requests of symmetrical size, the sequence including sequential groups of requests for the repositories, each group including requests for one or more bits of: the first file, the second file, or a combination of bits, based on a function identified by the vehicle, from both the first file and the second file. The vehicle receives responses to groups of requests, including a combination of bits based on the function, and a bit from the second file usable to solve the combination to extract a bit of the first file, and responsively solves the combination to extract the bit of the first file.

### TECHNICAL FIELD

The illustrative embodiments generally relate to methods and apparatuses for obscured attainment of specifically desired assets.

### BACKGROUND

With an ever-increasing number of applications inside the modern fully networked vehicle, there is a constant desire for the vehicle to download digital assets, such as data, from various databases, such as those controlled by third parties or original equipment manufacturers (OEMs). For example, a vehicle equipped with video streaming capabilities may want to retrieve a video asset from the cloud of a third-party content provider. The realm of practical asset download/obtainment applications could also extend to other vehicular applications, such as real live road map downloads, music streaming, internet browsing, etc.

For any vehicle retrieving asset files from any of the aforementioned applications, there is at least one major common problem in the form of privacy. Since the asset is typically requested by name or defined identifier, there is no real way to obscure the request, even when the request pertains to a sensitive file. Thus, the provider of the database can effectively have a record of every requested asset, revealing what was requested and when.

For example, a user may want live map information, but may not want to reveal a specific location where the user is present or headed. This desire does not stem from nefarious intent, but simply the desire people have not to be tracked and monitored, preferring instead that their personal habits remain their own. In another instance, a user may want to obtain a podcast or video file that may reveal political leanings or personal beliefs. This is information that many users would rather prefer to remain private unless they expressly chose to reveal it. It is also information that could be used to build a profile on the user for advertising, political fundraising, etc., resulting in a possible deluge of unrequested contacts.

In still a further example, law enforcement or other information-gathering agencies may want to conduct investigations or gather information without creating a clear record of what was requested and when, to evade detection by sophisticated counter-entities. In these and similar scenarios, the users are constrained by being forced to reveal, at least to the provide, the identification of the asset of interest, so that the correct asset can be provided. Then, at least, the provider (as well as anyone intercepting the request), knows the asset that is sought.

### SUMMARY

In a first illustrative embodiment, a vehicle includes one or more processors configured to receive a request for a download of a first file. The one or more processors are also configured to determine a first size of the first file requested by the request, determine a plurality of remote repositories that include the first file and determine a second file having a minimum size, based on the first size and included in the plurality of repositories. Further, the one or more processors are configured to plan a sequence of requests of symmetrical size, the sequence including sequential groups of requests for the repositories, each group including requests, for each repository of the plurality of repositories and for one or more bits of: the first file, the second file, or a combination of bits, based on a function identified by the vehicle, from both the first file and the second file.

Each request in the same group is for a different of the repositories, symmetrical in size, and requesting bits different from bits requested by other requests in the same group. The different bits include at least one of different bits from the first file, different bits from the second file, or bits from both the first and the second file combined based on the function and different from combination bits requested by other requests in the group.

The one or more processors are also configured to receive responses to a plurality of groups of requests, the responses including at least one combination of bits based on the function and at least one bit from the second file usable to solve the at least one combination to extract at least one bit of the first file and responsively solve the at least one combination to extract the at least one bit of the first file.

In a second illustrative embodiment, a non-transitory computer readable storage medium stores instructions that, when executed by one or more processors of a vehicle, cause the one or more processors to be configured to receive a request for a download of a first file and determine a first size of the first file requested by the request. The one or more processors are also configured to determine two remote repositories that include the first file and determine a second file having a minimum size, based on the first size and included in both repositories. Further, the one or more processors are configured to plan a sequence of requests of symmetrical size, the sequence including sequential groups of requests for both of the repositories, each group including requests, for both repositories and for one or more bits of: the first file, the second file, or a combination of bits, based on a function identified by the vehicle, from both the first file and the second file. Each request in a same group is: for a different of the repositories, symmetrical in size, and requesting bits different from bits requested by other requests in the same group, wherein the different bits include at least one of different bits from the first file, different bits from the second file, or bits from both the first and the second file combined based on the function and different from combination bits requested by other requests in the group. The one or more processors are also configured to receive responses to a plurality of groups of requests, the responses including at least one combination of bits based on the function and at least one bit from the second file usable to solve the at least one combination to extract at least one bit of the first file and responsively solve the at least one combination to extract the at least one bit of the first file.

In a third illustrative embodiment, a method includes receiving a request for a download of a first file and determining a first size of the first file requested by the request. The method also includes determining a plurality of remote repositories that include the first file and determining a second file having a minimum size, based on the first size and included in the plurality of repositories. Further, the method includes planning a sequence of requests of symmetrical size, the sequence including sequential groups of requests for the repositories, each group including requests, for each repository of the plurality of repositories and for one or more bits of: the first file, the second file, or a combination of bits, based on a function identified by the vehicle, from both the first file and the second file. Each request in a same group is: for a different of the repositories, symmetrical in size, and requesting bits different from bits requested by other requests in the same group, wherein the different bits include at least one of different bits from the first file, different bits from the second file, or bits from both the first and the second file combined based on the function and different from combination bits requested by other requests in the group. The method additionally includes receiving responses to a plurality of groups of requests, the responses including at least one combination of bits based on the function and at least one bit from the second file usable to solve the at least one combination to extract at least one bit of the first file and responsively solving the at least one combination to extract the at least one bit of the first file.

### BRIEF DESCRIPTION OF THE DRAWINGS

FIG. 1 shows an illustrative example of a vehicle and several repositories;

FIG. 2 shows an illustrative request handling process;

FIG. 3 shows an illustrative vehicle-side solution process to extract desired asset elements from a combination including undesired elements;

FIG. 4 shows an illustrative series of requests and results; and

FIGS. 5A and 5B show illustrative examples of an additional obscuration process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments propose methods and systems for obtaining/downloading desired assets while preserving the privacy of those requests from the providers sourcing the asset. Moreover, the requests are protected against channel eavesdroppers and wiretappers.

The proposed solution consists of a system and mechanisms involving data repositories (e.g., databases) that contain a file and copies of the file at discrete, individually referenceable locations, due to, for example, replication of a repository for providing more efficient response time. In the proposed example, the duplicative repositories do not communicate with each other, that is, each repository does not know what was requested from its counterpart.

The illustrative embodiments present requests for assets in a manner that does not reveal, to a particular repository, at least, any preference for one asset over another. That is, the requests may be symmetrical and an observer of a given request would not be able to glean a preference for which asset was actually desired. The vehicle is also capable of designing strategic request functions and sending versions to each repository, again, preserving obscurity through symmetry.

The request functions can be handled by the respective repositories and the requested asset (typically portions of an asset, such as a bit or bits) can be handled in accordance with the designated function and returned to the requesting vehicle. These requests may include elements of assets of no particular interest. The requests may also occur over multiple rounds, and then, for example, the receiving vehicle may “solve” the responses to extract only the desired elements of the desired assets. In at least one example, at least a subset of the undesired elements requested during the rounds of requests can be used to solve the responses, through a logical function such as XOR, wherein duplicatively requested bits, requested as part of a combination, can be removed from the combination by reference to those bits having been also discretely requested and provided. Hashing and other security functions can be used to further protect requests and responses, and moreover, individual requests, if observed, do not reveal the identity of the asset of interest.

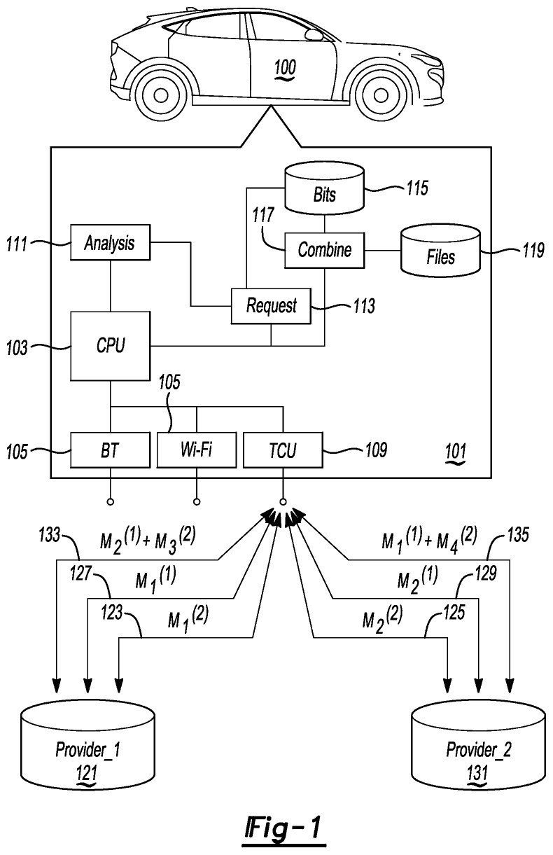

FIG. 1 shows an illustrative example of a vehicle and several repositories. In this illustrative example, the vehicle 100 includes an onboard computing system 101. While the examples shown are with respect to a vehicle computer, the same asset request and obscuration process could be used to handle asset requests from, for example, a mobile computing device such as a smart phone and could be processed by a processor thereof.

In this example, the vehicle computing system 101 includes one or more processors 103 and a plurality of communication mediums. In this example, those mediums include BLUETOOTH transceiver 105, Wi-Fi transceiver 107 and telematics control unit (TCU) 109. While not discussed in great detail, vehicles could also exchange requests over BLUETOOTH, for example, when in sufficient proximity to fulfil requests, to add a further layer of secrecy. That is, a vehicle could pass a portion of a request to another vehicle. The request itself does not reveal the asset of interest (which prevents the other vehicle from knowing what the asset of interest was), and having the other vehicle submit the request and return the results to the original vehicle means that even if every request from the original vehicle to the repositories was tracked, at least one request would be missing from the string of requests (having been serviced by the other vehicle). This further guards against an attempt to rebuild the request string and identify an asset of interest—if, for example, the duplicative repositories could communicate or an interloping user could access the requests from each disparate repository.

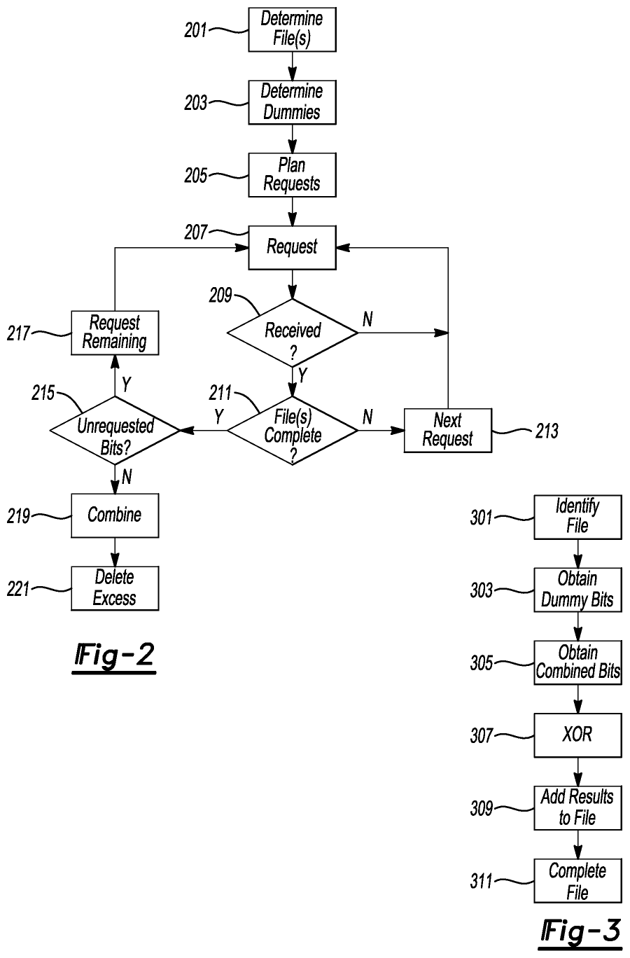

FIG. 2 shows an illustrative request handling process. In this illustrative example, there is an asset of interest, such as a file. The user may, for example, request a map file, a video file, audio file, etc. All of this content may provide some context for insight into the behavior, leanings or general preferences of that person. As such, people may want to keep such requests private, unless they expressly choose to share the information discernable based on the request.

If the asset were simply requested from a database, at least that database would know the information that the user would prefer remain private—i.e., the database, being required to deliver the asset, knows the identity of the asset. An interloper who intercepts the request may also be able to obtain the same information. Even requesting the asset in pieces (e.g., bits), does not solve the problem if the asset is singularly requested, because the reference to the asset still exists—that is, which asset, from which the bits are obtained, is still identified.

The illustrative embodiments solve this by requesting additional bits from a file of no particular interest. In the process shown, a single asset of interest is referenced and a single dummy asset is referenced, but it will be appreciated that the dummy bits can come from multiple sources and that the process can be used with regards to obtaining multiple assets, although there are aspects of the embodiments that benefit from symmetry, so expanding the ratios of assets or dummy files may account for this, in maintaining symmetry of requests (e.g., an equal number of bits of each file, relevant or otherwise) requested from a given repository. In the example presented, the process determines an asset of interest at 201, such as a requested file, and determines a dummy file at 203, which is a file that has at least enough discrete bits to complete the solution as explained in greater detail below. As one example, each file be divided into D\hat{ }M bits, where D is the number of databases to be used and M is the number of messages in each database.

The presence of the file of interest in a plurality of databases may be known or may be determined based on a query. If the databases/repositories are duplicative, knowing the file is in one will inform the system that the file is in all of them. Further, certain repositories may be designated as providers of certain files. Dummy files may include requests for comparable data or data of a minimum size needed to create the request sequence below, which in the example below is at least half the size of the original file. Dummy files may be identified by requests to databases for identification of files of a certain size. Files of a size over the minimum size required may be randomly chosen, some may be larger than the file of interest, so that a paradigm where the larger file is always the file of interest does not emerge.

Based on the number of requests needed and the number of databases accessed, the process then plans a sequence of iterative requests at 205. Some of these may be requests for discrete bits, others are requests for combinations of bits according to a formula, delivered with the request. Such formulas can be “solved” at the vehicle to extract bits of interest from the combination. However, since only the vehicle knows the bits of interest and which dummy bits to use to solve the formula, even observing the formula does not reveal which bits will be extracted by the solution.

For example, the vehicle may request two portions (e.g. bits) of two files, M1 and M2, using the specified (in the request) formula M₁1+M₁2. This formula can be solved for either M₁1 or M₁2 by using an XOR operation on the result returned, wherein the irrelevant portion is XOR'd with the returned result to produce the relevant bit(s). Someone viewing the request may know that either M1 or M2 was of interest, but not which. Not knowing which also precludes solving the response for the relevant bits, since there is no knowledge of the irrelevant bits to include in the XOR operation. Further, unless a viewing party (other than the intended recipient) has the irrelevant bits in their possession, they still cannot solve the XOR function. The intended recipient will obtain the irrelevant bits as part of a misdirection request submitted in a different request in the sequence of requests. Irrelevant, in this context, refers to bits not part of the desired asset, but those bits are not necessarily useless, as noted above.

The process then sends one of the sequence of requests at 207 and waits until response has been received. In one embodiment, the response is received from all repositories before the next request is sent at 213, in another embodiment, the response is received from a given repository before the next request is sent to that repository.

When the whole asset of interest is completely received at 211, the process may attempt to further mask the request by requesting additional irrelevant bits of no particular use at that time. In the example presented below, four bits of one file and two bits of another file are requested. This leaves two bits of the dummy file unrequested, and if true symmetry is desired, the process can also request the two bits of the dummy file or any previously unrequested bits at 217, which can also include a continued sequence of requests, even though there is no actual need for the bits provided in a response. This prevents someone who has the whole sequence of requests from determining which was the asset of interest based on which assets were only ultimately partially requested. On the other hand, this will use additional data and bandwidth, so can also be skipped if desired, since there are a number of protections present in the example as presented, even without the additional bit requests.

The process then combines solves the formula sent to the repositories for at least one bit, such as the XOR operation above, and then combines all the elements of the relevant asset to assemble the relevant asset at 219. The remaining unneeded data, such as bits from the dummy file, can then be discarded at 221.

FIG. 3 shows an illustrative vehicle-side solution process to extract desired asset elements from a combination including undesired elements. In this example, the process determines a desired asset (e.g., a file) at 301 and some number of dummy bits of another file that were obtained from sequential, symmetrical requests to repositories. Which dummy bits are needed can be known based on the specific formulas sent to the repository and the solution to the function to extract the desired bits, in this instance, and XOR function. For example, if the formula requested M₁1+M₁2 as above and the desired bit was M₁2, then the process would determine that a previously received dummy bit, M₁1, was needed to XOR with the response to the formula request in order to extract M₁2 at 303.

For each dummy bit obtained, the process also obtains the formula response from the repository at 305, in this example the result of M₁1+M₁2, and performs the logical operation to solve the response in order to extract M₁2, which in this instance is M₁1⊕M₁1+M₁2 at 307. This solution to the OR function requested by M₁1+M₁2 will extract only the bits in M₁2. The knowledge of what bits were requested and what bits should be removed (i.e. used as the XOR basis) will provide the vehicle with sufficient guidance as to how to extract the relevant bits. Anyone else viewing the request will not appreciate which bits are the relevant bits (as the request does not indicate this) and/or will lack the dummy bits (having been obtained by the vehicle in a prior request).

The results of the extraction, M₁2, are added to a list of all the file bits at 309 and then eventually assembled into the complete asset at 311.

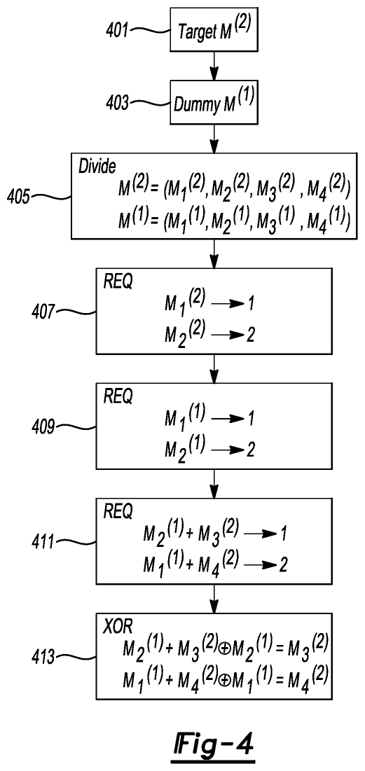

FIG. 4 shows an illustrative series of requests and results. In this example, the process shows the use of a file of interest M² and a dummy file M¹. The target M² is identified at 401 and the dummy file M¹ is identified at 403.

Then the process divides each file into four bits (in this example) at 405:

$$\begin{matrix}{M}^{2} = ( {M}_{1}^{2} , {M}_{2}^{2} , {M}_{3}^{2} , {M}_{4}^{2} ) \\ {M}^{1} = ( {M}_{1}^{1} , {M}_{2}^{1} , {M}_{3}^{1} , {M}_{4}^{1} )\end{matrix}$$

Once the process has all the bits comprising M², i.e., (M₁², M₂², M₃², M₄²), the process can reassemble the bits into a complete version of M². It obtains these bits through a sequence of symmetrical requests to databases containing duplicate versions of M² and M¹.

The first request, for example, is as follows at 407:
M₁²→1 (request the first bit of M² from repository 1)
M₂²→2 (request the second bit of M² from repository 2)

At this point, each repository has only received a single bit request and also would theoretically be able to assume that the request was for the file of interest, but to obscure the request, the next request can be as follows at 409:
M₁¹→1 (request the first bit of M¹ from repository 1)
M₂¹→2 (request the second bit of M¹ from repository 2)

Now both repositories have equal requests for bits from both files, and one bit of each, so symmetry is maintained and it is not apparent which is the actual file of interest. The next request is for an OR of bits at 411:
M₂¹+M₃²→1 (request the OR of the second bit of M¹ and the third bit of M² from repository 1)
M₁¹+M₄²→2 (request the OR of the first bit of M¹ and the fourth bit of M² from repository 2)

This request has several characteristics. First, each repository now has a request for two bits of each file, but without a common bit between the requests. That is, the first bit of the dummy file was originally requested from repository 1, but then was used in the OR request to repository 2, which does not reveal which bit of the OR request is used for extraction (which may be the case if the same bit had been discretely requested from repository 1). Thus each repository only knows that a portion of each file has been requested, for example the first and second bits of M¹ and the first and third bits of M² from repository 1.

At the same time, the vehicle now has all four bits of M² and enough bits of M¹ to solve the various OR functions applied using those same bits of M¹. So, the vehicle can essentially back out the OR of, for example, the second bit of M¹ and the third bit of M² (obtained from repository 1) by performing an XOR using the second bit of M¹ obtained discretely from repository 2 at 413. A comparable process is used to extract the third bit of M².

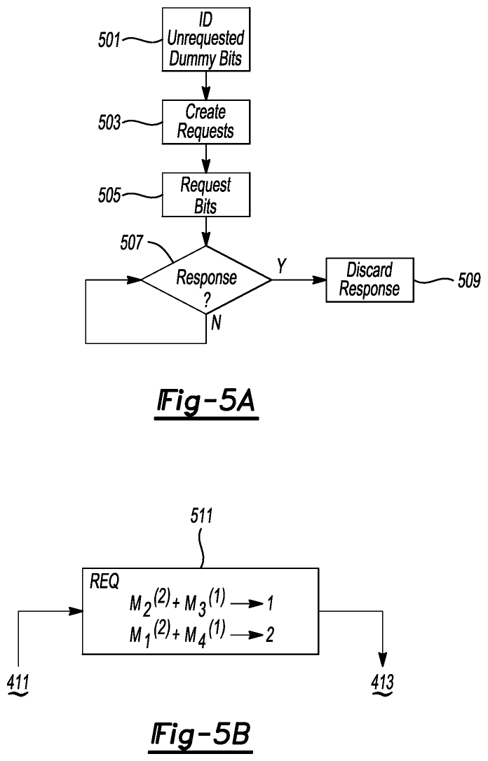

FIGS. 5A and 5B show illustrative examples of an additional obscuration process.

In the example shown in FIG. 5A, there may be remaining bits of M¹ that have not been requested, as they were not technically used by any of the equations and they related to the dummy file. If it is desired to prevent identification from considering the requests as a whole, then additional requests for the missing pieces of M¹ can be made, even though the results may not be used for any other purpose.

So, if this measure is desired, the process can identify the missing dummy bits at 501 and create requests for the missing dummy bits at 503, an example of which is shown with respect to FIG. 5B. These are symmetrical to requests made for the OR functions relating to the bits of interest, so that the existence or lack of a request of one type does not identify the file of interest. Those requests may then be sent sequentially at 505, or can even be interspersed with “legitimate” requests as desired.

When a response to a dummy request is received at 507, if the vehicle has no use for the results, the process can simply discard the response at 509. Alternatively, the responses can be saved and then deleted once the asset has been reassembled.

In FIG. 5B, for symmetry, the process requests at 511:
M₃¹+M₂²→1 (both bits that have not been requested from repository 1)
M₄¹+M₁2→2 (both bits that have not been requested from repository 2)

Now each repository has a request for three bits of a file, and each request includes bits not previously requested by the repository.

It may also be possible to use the preceding to request a file from a single repository without revealing the file of interest. If all of the preceding requests were sent, in order, to a single repository, there would still not be clear evidence of which file was of interest. Both files would have been requested in their entirety by the end, but the “solution” dummy bits would have been equally requested along with the “assembly” bits of interest, and symmetrically so. Thus it still is not clear which of the first two bits of which file are to be used for XOR and which are to be used for assembling the asset. This, however, may not be as private as downloading different bits of the same file from a plurality of databases as noted above. Further, the solution bits to solve the XOR reconstruction process would be included in requests, so theoretically the single database could solve the equation to know the bits of interest from a given OR combination. So, while a single database is contemplated and within the scope, it may not be the most efficient form of solution. Further, as all bits of both files would have to be downloaded in order not to show excessive interest in one file, this would require additional downloading, as opposed to the example where, by the end of the process, only a partial total set of bits for the dummy file is downloaded. Bits that are combined using OR are considered to have the same downloaded data/rate value as a single bit download, since combining the bits using OR does not increase the number of bits.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
one or more processors configured to:
receive a request for a download of a first file;
determine a first size of the first file requested by the request;
determine a plurality of remote repositories that include the first file;
determine a second file having a minimum size, based on the first size and included in the plurality of repositories;
plan a sequence of requests of symmetrical size, the sequence including sequential groups of requests for the repositories, each group including requests, for each repository of the plurality of repositories and for one or more bits of:
the first file, the second file, or a combination of bits, based on a function identified by the vehicle, from both the first file and the second file,
and each request in a same group for a different of the repositories, symmetrical in size, and requesting bits different from bits requested by other requests in the same group, wherein the different bits include at least one of different bits from the first file, different bits from the second file, or bits from both the first and the second file combined based on the function and different from combination bits requested by other requests in the group; and
receive responses to a plurality of groups of requests, the responses including at least one combination of bits based on the function and at least one bit from the second file usable to solve the at least one combination to extract at least one bit of the first file and
responsively solve the at least one combination to extract the at least one bit of the first file.

2. The vehicle of claim 1, wherein the minimum size is at least half the first size.

3. The vehicle of claim 1, wherein the minimum size is at least equal to the first size.

4. The vehicle of claim 1, wherein the second file is determined to be included in the plurality of repositories based at least on a request sent to the plurality of repositories to identify one or more files of at least the minimum size.

5. The vehicle of claim 1, wherein the second file is randomly chosen by the vehicle from files known to be included in a repository including the first file.

6. The vehicle of claim 1, wherein the function includes an AND function applied to the bits in the combination.

7. The vehicle of claim 6, wherein the solution to the at least one combination includes application of an XOR function using the at least one bit from the second file usable to solve the at least one combination.

8. A non-transitory computer readable storage medium storing instructions that, when executed by one or more processors of a vehicle, cause the one or more processors to be configured to:
receive a request for a download of a first file;
determine a first size of the first file requested by the request;
determine two remote repositories that include the first file;
determine a second file having a minimum size, based on the first size and included in both repositories;
plan a sequence of requests of symmetrical size, the sequence including sequential groups of requests for both of the repositories, each group including requests, for both repositories and for one or more bits of:
the first file, the second file, or a combination of bits, based on a function identified by the vehicle, from both the first file and the second file,
and each request in a same group for a different of the repositories, symmetrical in size, and requesting bits different from bits requested by other requests in the same group, wherein the different bits include at least one of different bits from the first file, different bits from the second file, or bits from both the first and the second file combined based on the function and different from combination bits requested by other requests in the group; and
receive responses to a plurality of groups of requests, the responses including at least one combination of bits based on the function and at least one bit from the second file usable to solve the at least one combination to extract at least one bit of the first file and responsively solve the at least one combination to extract the at least one bit of the first file.

9. The storage medium of claim 8, wherein the minimum size is at least half the first size.

10. The storage medium of claim 8, wherein the minimum size is at least equal to the first size.

11. The storage medium of claim 8, wherein the second file is determined to be included in the plurality of repositories based at least on a request sent to the plurality of repositories to identify one or more files of at least the minimum size.

12. The storage medium of claim 8, wherein the second file is randomly chosen by the vehicle from files known to be included in a repository including the first file.

13. The storage medium of claim 8, wherein the function includes an AND function applied to the bits in the combination.

14. The storage medium of claim 13, wherein the solution to the at least one combination includes application of an XOR function using the at least one bit from the second file usable to solve the at least one combination.

15. A method comprising:
receiving a request for a download of a first file;
determining a first size of the first file requested by the request;
determining a plurality of remote repositories that include the first file;
determining a second file having a minimum size, based on the first size and included in the plurality of repositories;
planning a sequence of requests of symmetrical size, the sequence including sequential groups of requests for the repositories, each group including requests, for each repository of the plurality of repositories and for one or more bits of:
the first file, the second file, or a combination of bits, based on a function identified by the vehicle, from both the first file and the second file,
and each request in a same group for a different of the repositories, symmetrical in size, and requesting bits different from bits requested by other requests in the same group, wherein the different bits include at least one of different bits from the first file, different bits from the second file, or bits from both the first and the second file combined based on the function and different from combination bits requested by other requests in the group; and
receiving responses to a plurality of groups of requests, the responses including at least one combination of bits based on the function and at least one bit from the second file usable to solve the at least one combination to extract at least one bit of the first file and responsively solving the at least one combination to extract the at least one bit of the first file.

16. The method of claim 15, wherein the minimum size is at least half the first size.

17. The method of claim 15, wherein the minimum size is at least equal to the first size.

18. The method of claim 15, wherein the second file is determined to be included in the plurality of repositories based at least on a request sent to the plurality of repositories to identify one or more files of at least the minimum size.

19. The method of claim 15, wherein the second file is randomly chosen by the vehicle from files known to be included in a repository including the first file.

20. The method of claim 15, wherein the function includes an AND function applied to the bits in the combination and wherein the solution to the at least one combination includes application of an XOR function using the at least one bit from the second file usable to solve the at least one combination.
